(19) United States
(12) Patent Application Publication
(10) Pub. No.: US 2012/0208148 A1
(43) Pub. Date: Aug. 16, 2012

(54) DRUG ALLUDING DENTAL IMPLANT

(76) Inventor: Pankaj P. Singh, Brookville, NY (US)

(21) Appl. No.: 13/025,028

(22) Filed: Feb. 10, 2011

(51) Int. Cl. A61C 8/00

(52) U.S. Cl. 433/173

(57) ABSTRACT

A dental implant has an implant body that releases drug(s) to the patient. In some embodiments, the dental implant body may be coated with drugs, such as anti-inflammatory drugs and/or anti-infective/antibiotic drugs. The drugs may be formulated in a time released or extended released formulation so as to deliver the drugs over an extended period of time. The drugs may be formulated to not only slowly deliver the drug substance, but to also provide a drug substance that may be delivered locally, with minimal systemic drug perfusion. The drug alluding implants of the present invention may help reduce or eliminated complications related to dental implant surgery.

### BACKGROUND OF THE INVENTION

The present invention relates to dental implants and methods for reducing surgical complications resulting from dental implant surgery. More particularly, the present invention related to dental implants capable of alluding drugs to the patient.

A dental implant is a support used in dentistry that is used to hold a restoration. Most dental implants placed today are root-form endosseous implants, i.e., they appear similar to an actual tooth root and are placed within the bone. The bone of the jaw accepts and osseointegrates with the implant. The osseointegration is the component of the implant procedure that makes it resemble the look and feel of a natural tooth.

A typical implant consists of a titanium screw (resembling a tooth root) with a roughened or smooth surface. The majority of dental implants are made out of commercially pure titanium, which is available in 4 grades depending upon the amount of carbon and iron contained. Titanium 6AL-4V, signifying a titanium alloy containing 6% aluminium and 4% vanadium alloy, is believed to offer similar osseointegration levels as commercially pure titanium. Implant surfaces may be modified by plasma spraying, anodizing, etching or sandblasting to increase the surface area and the integration potential of the implant.

Failure of a dental implant is often related to failure to osseointegrate correctly. Dental implants can develop a condition called peri-implantitis. This is an inflammatory condition of the mucosa and/or bone around the implant which may result in bone loss and eventual loss of the implant. Currently there is no universal agreement on the best treatment for peri-implantitis. In addition, as with any surgical procedure, a risk of infection exists for patients receiving dental implants. Prophylactic antibiotics are often given to patients to help reduce this risk. However, the delivery of systemic antibiotics may be undesirable for some patients.

As can be seen, there is a need for methods and apparatus placing dental implants while reducing the risk of infection and inflammation.

### SUMMARY OF THE INVENTION

In one aspect of the present invention, a dental implant comprises an implant body; and a drug substance adapted to be released from the implant body when the implant is installed in a patient.

In another aspect of the present invention, a method for reducing or preventing complications from dental implant surgery comprises applying a drug substance to at least a portion of a dental implant body; and placing the drug substance-applied dental implant into a patient.

In a further aspect of the present invention, a method for decreasing time for osseointegration of a dental implant comprises positioning a dental implant in a patient, wherein the dental implant is coated with a drug substance adapted to permit bone healing.

These and other features, aspects and advantages of the present invention will become better understood with reference to the following drawings, description and claims.

### BRIEF DESCRIPTION OF THE DRAWINGS

FIG. 1 is a side view of a dental implant body according to an exemplary embodiment of the present invention;

FIG. 2 is a side view of a dental implant abutment; and

FIG. 3 is side view of the assembled dental implant of FIGS. 1 and 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a dental implant that releases drug(s) to the patient. In some embodiments, the dental implant may be coated with drugs, such as anti-inflammatory drugs and/or anti-infective/antibiotic drugs. The drugs may be formulated in a time released or extended released formulation so as to deliver the drugs over an extended period of time. The drugs may be formulated to not only slowly deliver the drug substance, but to also provide a drug substance that may be delivered locally, with minimal systemic drug perfusion. The drug alluding implants of the present invention may help reduce or eliminated complications related to dental implant surgery.

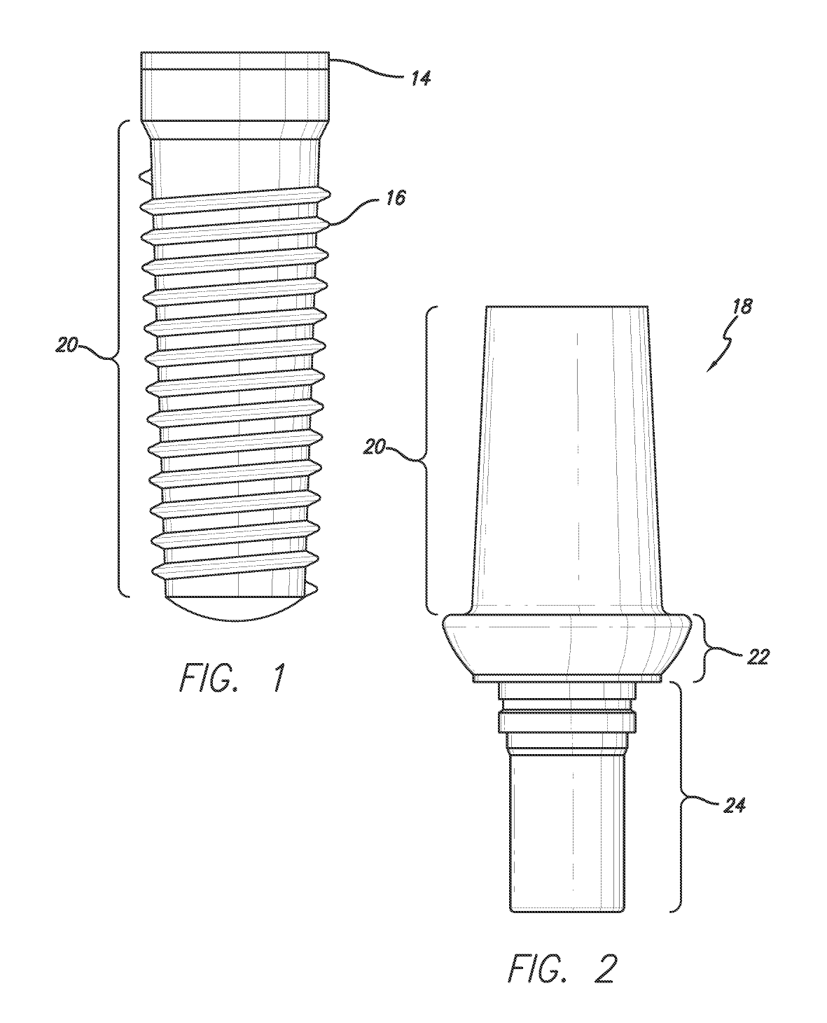

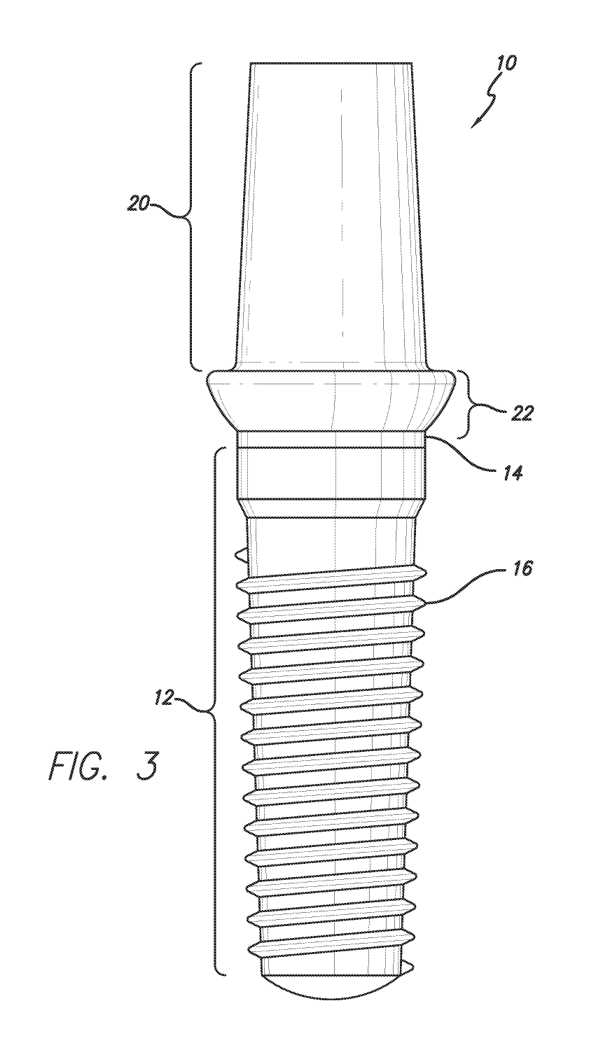

Referring to FIGS. 1 through 3, a dental implant 10 may include an implant body 12 and an implant collar 14. The implant body 12 may by conical shaped, similar to roots of a tooth and may have a perforated surface texture. The implant body 12 may have external threads 16. The threads 16 may be self-cutting threads. The implant body 12 may have a hollow interior.

The dental implant 10 may also include an abutment unit 18. The abutment unit 18 may include an abutment body 20, an abutment collar 22 and an internal connector 24. The internal connector 24 may fit inside of the hollow interior of the implant body 12. The bottom of the abutment collar 22 may fit against the implant collar 14.

The dental implant 10 may be coated with a drug substance. In some embodiments, portions of the dental implant 10 may be coated with the drug substance. For example, the dental implant body 12, the implant collar 16, the abutment body 20, the abutment collar 22 and/or the internal connector 24 may be coated with the drug substance. The drug substance may include one or more active compounds. In some embodiments, the drug substance may include an antibiotic drug. Examples of antibiotic drugs useful in the present invention include, but are not limited to, quinolone, macrolide, glycopeptide, oxazolidinone, β-lactams (including amoxicillin, ampicillin, augmentin, bacampicillin, carbenicillin, cloxacillin, dicloxacillin, flucloxacillin, methicillin, mezlocillin, nafcillin, oxacillin, penicillin G, penicillin V, piperacillin, pivampicillin, pivmecillinam, ticarcillin, sulbactam, tazobactam, clavulanate), azithromycin, bactrim, cephalosporins (cefaclor, cefadroxil, cefamandole, cefazolin, cefdinir, cefditoren, cefepime, cefixime, cefonicid, cefoperazone, cefotaxime, cefotetan, cefoxitin, cefpodoxime, cefprozil, ceftazidime, ceftibuten, ceftizoxime, ceftriaxone, cefuroxime, cephalexin, cephalothin, cephapirin, cephradine), aminoglycosides (including gentamycin, streptomycin, amikacin, kanamycin, viomycin, capreomycin), ethionamide, prothionamide, cycloserine, dapsone, clofazimine, tetracyclines (tetracycline, doxycycline, chlortetracycline, oxytetracycline, minocycline demeclocycline), oxazolidinones (linezolid, eperezolid), metronidazole, rifabutin, isoniazonid, ethambutol, and combinations thereof.

In some embodiments, the drug substance may include an anti-inflammatory agent. Exemplary anti-inflammatory agents include, for example, steroids (e.g., cortisol, cortisone, fludrocortisone, prednisone, 6.alpha.-methylprednisone, triamcinolone, betamethasone or dexamethasone), and nonsteroidal antiinflammatory drugs (NSAIDS (e.g., aspirin, acetaminophen, tolmetin, ibuprofen, mefenamic acid, piroxicam, nabumetone, rofecoxib, celecoxib, etodolac or nimesulide). Further examples of anti-inflammatory agents include, for example, aceclofenac, acemetacin, e-acetamidocaproic acid, acetaminophen, acetaminosalol, acetanilide, acetylsalicylic acid, S-adenosylmethionine, alclofenac, alclometasone, alfentanil, algestone, allylprodine, alminoprofen, aloxiprin, alphaprodine, aluminum bis(acetylsalicylate), amcinonide, amfenac, aminochlorthenoxazin, 3-amino-4-hydroxybutyric acid, 2-amino-4-picoline, aminopropylori, aminopyrine, amixetrine, ammonium salicylate, ampiroxicam, amtolmetin guacil, anileridine, antipyrine, antrafenine, apazone, beclomethasone, bendazac, benorylate, benoxaprofen, benzpiperylon, benzydamine, benzylmorphine, bermoprofen, betamethasone, betamethasone-17-valerate, bezitramide, .alpha.-bisabolol, bromfenac, p-bromoacetanilide, 5-bromosalicylic acid acetate, bromosaligenin, bucetin, bucloxic acid, bucolome, budesonide, bufexamac, bumadizon, buprenorphine, butacetin, butibufen, butorphanol, carbamazepine, carbiphene, carprofen, carsalam, chlorobutanol, chloroprednisone, chlorthenoxazin, choline salicylate, cinchophen, cinmetacin, ciramadol, clidanac, clobetasol, clocortolone, clometacin, clonitazene, clonixin, clopirac, cloprednol, clove, codeine, codeine methyl bromide, codeine phosphate, codeine sulfate, cortisone, cortivazol, cropropamide, crotethamide, cyclazocine, deflazacort, dehydrotestosterone, desomorphine, desonide, desoximetasone, dexamethasone, dexamethasone-21-isonicotinate, dexoxadrol, dextromoramide, dextropropoxyphene, deoxycorticosterone, dezocine, diampromide, diamorphone, diclofenac, difenamizole, difenpiramide, diflorasone, diflucortolone, diflunisal, difluprednate, dihydrocodeine, dihydrocodeinone enol acetate, dihydromorphine, dihydroxyaluminum acetylsalicylate, dimenoxadol, dimepheptanol, dimethylthiambutene, dioxaphetyl butyrate, dipipanone, diprocetyl, dipyrone, ditazol, droxicam, emorfazone, enfenamic acid, enoxolone, epirizole, eptazocine, etersalate, ethenzamide, ethoheptazine, ethoxazene, ethylmethylthiambutene, ethylmorphine, etodolac, etofenamate, etonitazene, eugenol, felbinac, fenbufen, fenclozic acid, fendosal, fenoprofen, fentanyl, fentiazac, fepradinol, feprazone, floctafenine, fluazacort, flucloronide, flufenamic acid, flumethasone, flunisolide, flunixin, flunoxaprofen, fluocinolone acetonide, fluocinonide, fluocinolone acetonide, fluocortin butyl, fluocortolone, fluoresone, fluorometholone, fluperolone, flupirtine, fluprednidene, fluprednisolone, fluproquazone, flurandrenolide, flurbiprofen, fluticasone, formocortal, fosfosal, gentisic acid, glafenine, glucametacin, glycol salicylate, guaiazulene, halcinonide, halobetasol, halometasone, haloprednone, heroin, hydrocodone, hydrocortamate, hydrocortisone, hydrocortisone acetate, hydrocortisone succinate, hydrocortisone hemisuccinate, hydrocortisone 21-lysinate, hydrocortisone cypionate, hydromorphone, hydroxypethidine, ibufenac, ibuprofen, ibuproxam, imidazole salicylate, indomethacin, indoprofen, isofezolac, isoflupredone, isoflupredone acetate, isoladol, isomethadone, isonixin, isoxepac, isoxicam, ketobemidone, ketoprofen, ketorolac, p-lactophenetide, lefetamine, levallorphan, levorphanol, levophenacyl-morphan, lofentanil, lonazolac, lomoxicam, loxoprofen, lysine acetylsalicylate, mazipredone, meclofenamic acid, medrysone, mefenamic acid, meloxicam, meperidine, meprednisone, meptazinol, mesalamine, metazocine, methadone, methotrimeprazine, methylprednisolone, methylprednisolone acetate, methylprednisolone sodium succinate, methylprednisolone suleptnate, metiazinic acid, metofoline, metopon, mofebutazone, mofezolac, mometasone, morazone, morphine, morphine hydrochloride, morphine sulfate, morpholine salicylate, myrophine, nabumetone, nalbuphine, nalorphine, 1-naphthyl salicylate, naproxen, narceine, nefopam, nicomorphine, nifenazone, niflumic acid, nimesulide, 5′-nitro-2′-propoxyacetanilide, norlevorphanol, normethadone, normorphine, norpipanone, olsalazine, opium, oxaceprol, oxametacine, oxaprozin, oxycodone, oxymorphone, oxyphenbutazone, papavereturn, paramethasone, paranyline, parsalmide, pentazocine, perisoxal, phenacetin, phenadoxone, phenazocine, phenazopyridine hydrochloride, phenocoll, phenoperidine, phenopyrazone, phenomorphan, phenyl acetylsalicylate, phenylbutazone, phenyl salicylate, phenyramidol, piketoprofen, piminodine, pipebuzone, piperylone, pirazolac, piritramide, piroxicam, pirprofen, pranoprofen, prednicarbate, prednisolone, prednisone, prednival, prednylidene, proglumetacin, proheptazine, promedol, propacetamol, properidine, propiram, propoxyphene, propyphenazone, proquazone, protizinic acid, proxazole, ramifenazone, remifentanil, rimazolium metilsulfate, salacetamide, salicin, salicylamide, salicylamide o-acetic acid, salicylic acid, salicylsulfuric acid, salsalate, salverine, simetride, sufentanil, sulfasalazine, sulindac, superoxide dismutase, suprofen, suxibuzone, talniflumate, tenidap, tenoxicam, terofenamate, tetrandrine, thiazolinobutazone, tiaprofenic acid, tiaramide, tilidine, tinoridine, tixocortol, tolfenamic acid, tolmetin, tramadol, triamcinolone, triamcinolone acetonide, tropesin, viminol, xenbucin, ximoprofen, zaltoprofen and zomepirac.

In some embodiments of the present invention, the drug coated on the dental implant 10 may be a healing accelerator. In some embodiments of the present invention, hyaluronic acid may be used as a healing accelerator.

In some embodiments of the present invention, the drug coated on the dental implant 10 may be formulated as a controlled, sustained, extended or time released formulation. The terms “controlled release,” “sustained release,” “extended release,” and “timed release” are intended to refer interchangeably to any drug-containing formulation in which release of the drug is not immediate, i.e., with a “controlled release” formulation, oral administration does not result in immediate release of the drug into an absorption pool. The terms are used interchangeably with “nonimmediate release” as defined in Remington: The Science and Practice of Pharmacy, 21.sup.st Ed., Gennaro, Ed., Lippencott Williams & Wilkins (2003). Exemplified extended release formulations that can be used in delivering a compound of the present invention include those described in U.S. Pat. Nos. 6,635,680; 6,624,200; 6,613,361; 6,613,358, 6,596,308; 6,589,563; 6,562,375; 6,548,084; 6,541,020; 6,537,579; 6,528,080 and 6,524,621, each of which is hereby incorporated herein by reference. Controlled release formulations of particular interest include those described in U.S. Pat. Nos. 6,607,751; 6,599,529; 6,569,463; 6,565,883; 6,482,440; 6,403,597; 6,319,919; 6,150,354; 6,080,736; 5,672,356; 5,472,704; 5,445,829; 5,312,817 and 5,296,483, each of which is hereby incorporated herein by reference. Those skilled in the art will readily recognize other applicable sustained release formulations.

The dental implant 10 may be coated by any conventional means known in the art. For example, a solution or suspension of drug substance in a solvent may be provided. The solution or suspension may be applied on at least a portion of the dental implant 10. In other embodiments, the dental implant 10 may be dipped in the drug-containing solution or suspension. The solvent may be removed to provide a dried drug coating on the surface of the dental implant 10.

Portions of the dental implant 10, such as the implant body 12, may contain pores or surface imperfections. The drug coating may be applied to occupy these pores and/or surface imperfections. In some embodiments, the drug substance may be applied during anodization of the implant.

In some embodiments of the present invention, multiple drug substances (or multiple formulations of the same or different drug substances) may be applied to the dental implant 10. For example, an immediate release antibiotic and/or anti-inflammatory may be applied on the exterior of the implant body. Under this immediate release drug coating may be disposed one or more non-immediate release drug substances. In other embodiments, one type of drug substance may be coated on a portion of the dental implant 10 while another type of drug substance may be coated on another portion of the dental implant 10.

In addition to antibiotics, anti-inflammatory and healing accelerator drugs being coated on the dental implant 10, other substances may be coated on the dental implant 10. For example, to help speed the osseointegration process, certain drug substances, generically described as bone healing drugs, may be coated on the dental implant 10. These drug substances may promote bone formation at and around the implant. Examples compounds useful in the present invention may include the osteoinductive agent, bone morphogenetic protein (BMP) and derivatives thereof, NELL peptides, statins, EP4 agonists, and the like.

While the above description discusses coating the dental implant 10 with a drug substance, this may include any or all of the parts of the dental implant. For example, a drug substance may be coated on the implant neck, implant collar 14 and/or the abutment unit 18.

It should be understood, of course, that the foregoing relates to exemplary embodiments of the invention and that modifications may be made without departing from the spirit and scope of the invention as set forth in the following claims.

What is claimed is:

1. A dental implant comprising:
a drug substance adapted to be released from the dental implant when the dental implant is installed in a patient.

2. The dental implant of claim 1, wherein the dental implant includes an implant body, the implant body includes a plurality of threads, wherein at least a portion of the threads have the drug substance coated thereupon.

3. The dental implant of claim 1, wherein the drug substance includes an anti-inflammatory drug.

4. The dental implant of claim 3, wherein the anti-inflammatory drug is selected from the group consisting of Naprosyn, naproxen, COX-1 inhibitors and COX-2 inhibitors.

5. The dental implant of claim 1, wherein the drug substance includes an antibiotic drug.

6. The dental implant of claim 5, wherein the antibiotic drug is selected from the group consisting of amoxicillin, amoxicillin clavulanate, azithromycin and sulfamethoxazole/trimethoprim.

7. The dental implant of claim 1, wherein the drug substance includes a bone healing drug.

8. The dental implant of claim 7, wherein the bone healing drug is a bone morphogenetic protein.

9. The dental implant of claim 1, wherein the drug substance includes a healing accelerator.

10. The dental implant of claim 9, wherein the healing accelerator is hyaluronic acid.

11. The dental implant of claim 1, wherein the drug substance includes more than one drug substance.

12. The dental implant of claim 11, wherein the drug substance includes a combination of at least two of a) at least one anti-inflammatory drug, b) at least one antibiotic drug, and c) at least one bone healing drug.

13. The dental implant of claim 1, wherein the drug substance is formulated in a non-immediate release formulation.

14. The dental implant of claim 1, wherein one drug substance is formulated in a non-immediate release formulation and another drug substance is formulated in an immediate release formulation.

15. A method for reducing or preventing complications from dental implant surgery, the method comprising:
applying a drug substance to at least a portion of a dental implant; and
placing the drug substance-applied dental implant into a patient.

16. The method of claim 15, further comprising alluding the drug substance from the dental implant to the patient.

17. The method of claim 15, wherein the drug substance is selected from the group consisting of anti-inflammatory drugs, antibiotic drugs and bone healing drugs.

18. A method for decreasing time for osseointegration of a dental implant, the method comprising:
positioning a dental implant in a patient, wherein the dental implant is coated with a drug substance adapted to permit bone healing.

19. The method of claim 18, wherein the drug substance is a bone morphogenetic protein.

20. The method of claim 18, further comprising coating the dental implant with a second drug substance, the second drug substance being selected from the group consisting of an anti-inflammatory drug and an antibiotic drug.
